(19) United States
(12) Patent Application Publication
(10) Pub. No.: US 2006/0238601 A1
(43) Pub. Date: Oct. 26, 2006

(54) Thermal type image forming apparatus

(75) Inventor: Dong-Su Nam, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/253,587

(22) Filed: Oct. 20, 2005

(30) Foreign Application Priority Data
Apr. 20, 2005 (KR) 2005-0032769

(51) Int. Cl. B41J 25/304

(52) U.S. Cl. 347/197

(57) ABSTRACT

A thermal type image forming apparatus which has a recording head with a plurality of thermal spots facing a recording medium to heat the recording medium. The thermal spots are selectively activated to form images on the recording medium. A support structure has a flat pressing plate pressing the recording medium to the recording head so that the recording medium can make contact with the recording head to form images.

### CROSS-REFERENCE TO RELATED APPLICATIONS

This application claims the benefit under 35 U.S.C. § 119(a) of Korean Patent Application No. 10-2005-0032769, filed on Apr. 20, 2005, the entire disclosure of which is hereby incorporated by reference.

### BACKGROUND OF THE INVENTION

1. Field of the Invention

The present invention relates to an image forming apparatus. More particularly, the present invention relates to a thermal type image forming apparatus in which images are formed by heating a recording medium.

2. Description of Related Art

FIG. 1 is a cross-sectional view illustrating part of a conventional thermal type image forming apparatus.

The conventional image forming apparatus 10 includes a recording head 11 which faces a recording medium P for heating the recording medium P. A platen roller 15 presses the recording medium P toward the recording head 11. A transport roller 20 transports the recording medium P. On a surface of the recording head 11, a plurality of thermal spots 13 are arranged along the width of the recording medium P. The platen roller 15 has an outer circumference made of a resilient rubber material and acts as an idle roller which frictionally rotates with the recording medium moving forward along a direction indicated by the arrow. The thermal spots 13 are selectively heated to form images on the recording medium P when the recording medium P passes through the recording head 11 and the platen roller 15.

However, in the conventional thermal type image forming apparatus 10, the platen roller 15 is rotated when the images are formed. Therefore, it is relatively difficult to consistently maintain pressure on the recording medium P along the width of the recording medium P. As a result, the ink density of a printed image can become thin, thus, resulting in image degradation.

Additonally, in the conventional thermal type image forming apparatus 10, a temperature difference between the thermal spots 13 and the recording medium P produces a density difference in the printed image. Therefore, the density of the printed image may change depending on when the image forming apparatus 10 is installed.

Accordingly, there is a need for an improved thermal type image forming apparatus having a support structure other than the platen roller for pressing the recording medium toward the recording head.

### SUMMARY OF THE INVENTION

An aspect of the present invention is to address at least the above problems and/or disadvantages and to provide at least the advantages described below. Accordingly, an aspect of the present invention is to provide a thermal type image forming apparatus having a support structure other than the platen roller for pressing the recording medium toward the recording head.

According to an aspect of the present invention, there is provided a thermal type image forming apparatus comprising a recording head having a plurality of thermal spots facing a recording medium to heat the recording medium. The thermal spots are selectively activated to form images on the recording medium. A support structure has a flat pressing plate which presses the recording medium to the recording head so that the recording medium can make contact with the recording head to form images.

The thermal type image forming apparatus may further comprise a preheating member which preheats the recording medium before the recording medium passes through the thermal spots of the recording medium.

The preheating member may include a heater making contact with the support structure, and the heat from the heater may be transmitted to the pressing plate so that the recording medium can be preheated.

The preheating member may be set to heat the recording medium to a temperature range of about 20 to 30° C. before the images are formed on the recording medium.

The pressing plate may be made of a metallic material.

The pressing plate may have a coat which reduces friction with the recording medium.

The thermal type image forming apparatus may further comprise a pushing element which presses the plate of the support structure toward the recording head. The pushing element may have a spring of which one end is connected to the recording head and the other end is connected to the support structure.

The thermal type image forming apparatus may further comprise a rotating member which rotates the recording head to allow the thermal spots of the recording head to face and heat the both sides of the recording medium.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, and features, and advantages of certain exemplary embodiments of the present invention will be more apparent from the following description taken in conjunction with the accompanying drawings, in which:

FIG. 1 is a cross-sectional view illustrating part of a conventional thermal type image forming apparatus;

FIGS. 2A and 2B are cross-sectional views illustrating a thermal type image forming apparatus according to an exemplary embodiment of the present invention;

FIG. 3 is an exploded view illustrating a rotating structure of the recording head shown in FIGS. 2A and 2B;

FIGS. 4A through 4I are schematic diagram illustrating rotation of the recording head of FIG. 3; and

FIG. 5 is a cross-sectional view illustrating an exemplary recording medium applied to a thermal type image forming apparatus.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

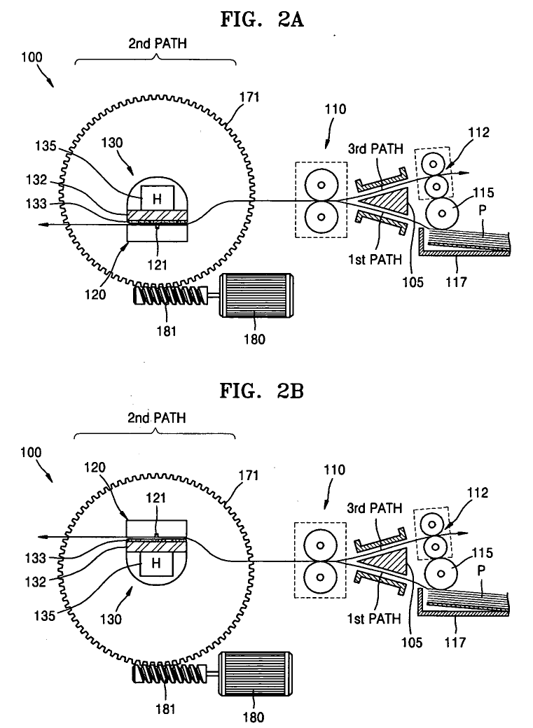

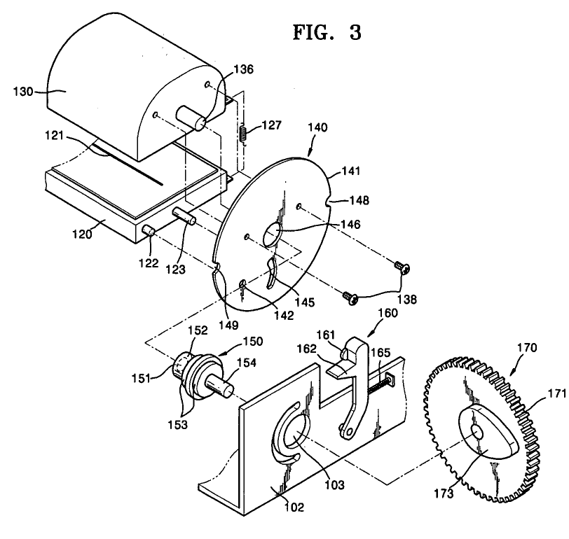

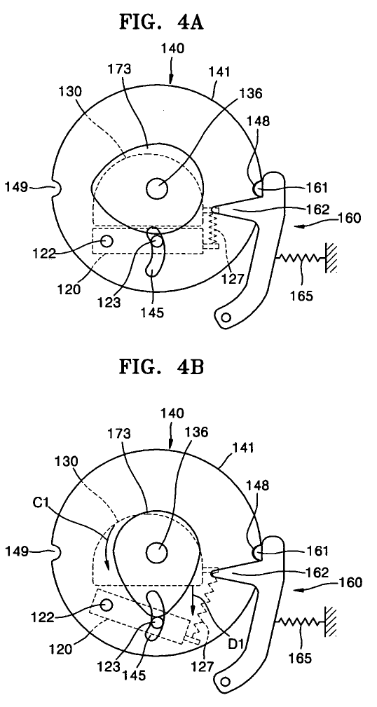

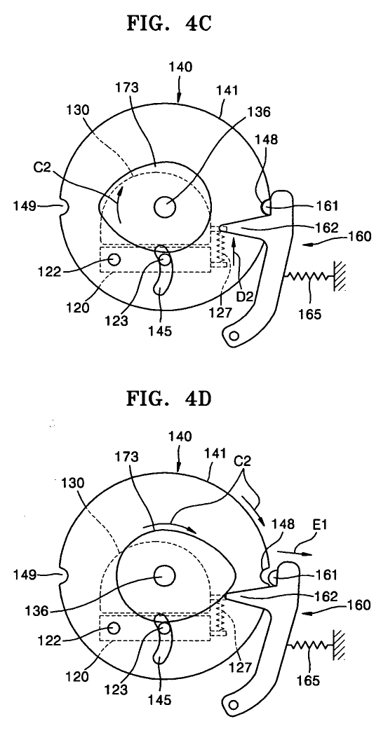

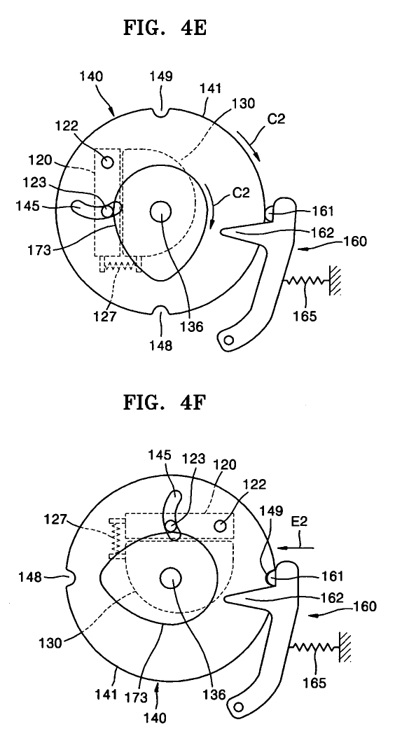

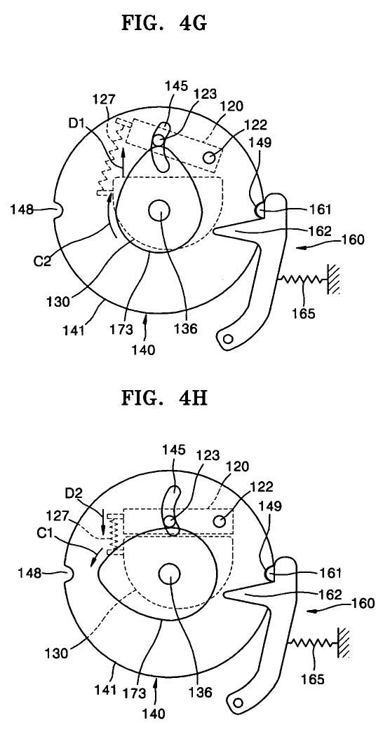

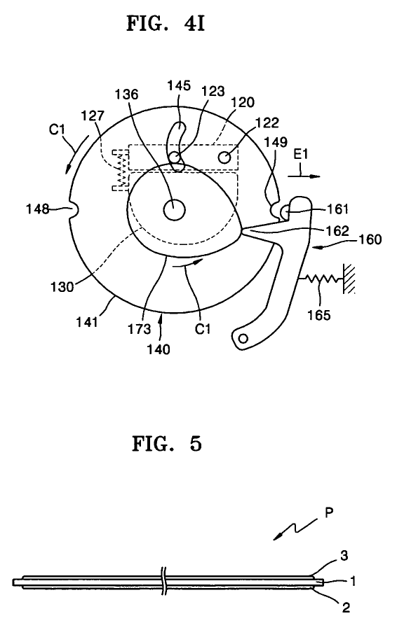

FIGS. 2A and 2B are cross-sectional views illustrating a thermal type image forming apparatus according to an exemplary embodiment of the present invention. FIG. 3 is an exploded view illustrating a rotating structure of the recording head shown in FIGS. 2A and 2B. FIGS. 4A through 4I are schematic diagrams illustrating rotation of the recording head of FIG. 3 and FIG. 5 is a cross-sectional view illustrating an exemplary recording medium applied to a thermal type image forming apparatus in accordance with an exemplary embodiment of the present invention.

Referring to FIGS. 2A and 2B, the thermal type image forming apparatus 100 according to the exemplary embodiments of the present invention has first, second, and third paths for transporting a recording medium P. The first path is for transporting the recording medium P to the second path. The second path is to print images on the recording medium P. The third path is to discharge the recording medium P during or after the printing.

A recording medium guide 105 is prepared between the first and the second paths. The recording medium guide 105 guides the recording medium P fed from the first path to the second path, and from the second path to the third path during printing. The transport roller 110 transports the recording medium P from the first path to the second path, from the second path to the third path, and the third path to the second path.

The recording medium P used in the image forming apparatus 100 may have a structure as shown in FIG. 5. Referring to FIG. 5, the recording medium P may have an ink layers 2 and 3 having predetermined colors on both surfaces (first and second surfaces) of a base sheet 1. Each ink layer 2 and 3 may have a single layer structure such as for a monochromatic ink or a multilayer structure for a multi color print. For example, a first ink layer 2 having two layers for yellow and magenta may be stacked on the first surface, and a second ink layer 3 having one layer for cyan may be stacked on the second surface.

For implementing color images, the base sheet 1 of the recording medium P may be transparent and an opaque membrane may be formed on the surface of one of the ink layers 2 or 3, for example, the first ink layer. If the recording medium P is viewed from the side of the second surface after forming images on the first and second surfaces of the recording medium P, each image having colors (e.g., cyan, magenta, and yellow) are superimposed to reproduce a complete color image. On the other hand, if the base sheet 1 of the recording medium P is opaque, duplex printing can be implemented. During duplex printing, different images are formed on the first and second surfaces of the recording medium P, respectively.

In the second path, there is a recording head 120 for forming image by heating the recording medium P, and a support structure 130 for pressing the recording medium P transported across the second path to allow the recording head 120 to make contact with the recording medium P. A thermal print head (TPH) may be used as the recording head 120. A plurality of thermal spots 121 are arranged along the width of the recording medium P on a surface of the recording head 120 facing the recording medium P to provide a line as shown in FIG. 3. When the recording medium P is transported across the second path, the thermal spots 121 are selectively activated, so that the ink layers 2 and 3 of the recording medium P are developed to produce images on the recording medium P. Typically, the thermal spots are heated to a temperature of about 150 through 170° C.

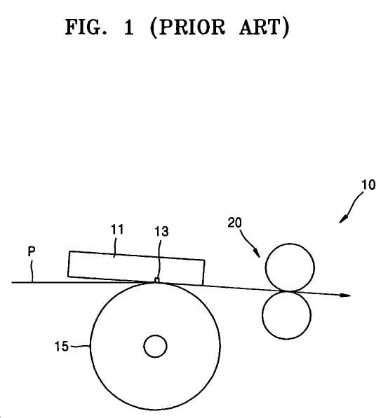

The support structure 130 has a flat pressing plate 132 facing the recording head 120 for pressing the recording medium P toward the recording head 120. Preferably, the pressing plate 132 is made of a metallic material. Since the pressing plate 132 according to the exemplary embodiments of the present invention is not a roller type (as shown FIG. 1), the pressure is consistently maintained along the width of the recording medium P. The pressing plate 132 has an area enough to cover the thermal spot line (shown in FIG. 3). Also, a coating layer 133 for reducing friction is provided on the surface of the pressing plate 132 facing the recording medium P to ensure relatively smooth transport.

The support structure 130 further has a preheating member for preheating the recording medium. The preheating member includes a heater 135 installed in an inner space of the support structure 130. The heater 135 may be a thermal core type, a halogen lamp type, or an induction heater (IH) type. The heater 135 makes contact with the pressing plate 132 made of a metallic material. Therefore, when the heater 135 is activated, the pressing plate 132 is also heated by thermal conduction. As a result, the recording medium P is preheated by passing through the side of the pressing plate 132 before arriving at the thermal spots 121. The preheating member is adjusted to heat the recording medium up to a temperature of 20 through 30° C. Accordingly, it is possible to consistently maintain a temperature of the recording medium P passing through the thermal spots 121 regardless of an ambient temperature around the image forming apparatus 100. Therefore, it is possible to consistently maintain ink density of a printed image.

As shown in FIGS. 2A and 2B, the image forming apparatus 100 according to the exemplary embodiments of the present invention has a function of sequentially forming images on the first (lower) surface and the second (upper) surface of the recording medium P by rotating the recording head 120 and the support structure 130 about 180-degrees. Later, a rotating member for implementing the above function will be described in detail.

In the third path, there is a discharge roller 112 for discharging the recording medium P. The discharge roller 112 may be associated with a pick-up roller 115 so that they can be driven by one driving motor (not shown).

The recording medium P is loaded on a cassette 117 and extracted one-by-one by the pick-up roller 115. Then, the recording medium P is fed from the first path to the second path through the transport roller 110. As shown in FIG. 2A, the recording head 120 faces the first surface of the recording medium P at a first position, and the pressing plate 132 of the support structure 130 presses the recording medium P toward the recording head 120. The transport roller 110 transports the recording medium P from the second path to the third path. Meanwhile, the heater 135 of the support structure 130 is activated, so that the recording medium P is preheated while sliding through and making contact with the pressing plate 132. The thermal spots 121 of the recording head are selectively activated and the first surface of the recording medium P is heated to form images.

After printing of the first surface is complete, the recording head 120 and the support structure 130 move to a second position as shown in FIG. 2B. The recording medium P is transported from the third path to the second path through the transport roller 110. Therefore, the second surface of the recording medium P faces the recording head 120, and is pressed toward the pressing plate 132 of the support structure 130. Then, an image is formed on the second surface of the recording medium P while the transport roller 110 transports the recording medium from the second path to the third path again. After the images are formed on the second surface, the recording medium P is discharged out of the image forming apparatus 100 through the discharge roller 112.

Now, a recording head rotating means for rotating the recording head 120 and the support structure 130 will be described in detail.

Referring to FIG. 3, a hinge shaft 122 is arranged on one side of the recording head 120. The hinge shaft 122 is inserted into a hinge hole 142 provided in a support bracket 140. The recording head 120 rotatably engages the support bracket 140 around the hinge hole 142. The support structure 130 is preferably engaged into the support bracket 140 by a screw 138. The support structure 130 is elastically biased to make contact with the recording head 120 by a tensile coil spring 127 of which one end is connected to the recording head 120 and the other end is connected to the support structure 130.

A protrusion 123 is arranged on one side of the recording head 120 and is inserted into a thru-hole provided in the support bracket 140. The thru-hole 145 has a crescent shape in order to allow the recording head 120 to move into and out of contact with the support structure 130. In addition, since the recording head 120 rotates around the hinge hole 142 to make contact with or separate from the support structure 130. The thru-hole 145 preferably has a circular arc shape around the hinge hole 142.

A bushing 150 includes an inner circumference 152, and first, second, and third outer circumferences 152, 153, and 154 that are coaxially structured. The shaft 136 of the support structure 130 passes through a support hole 146 provided in the center of the support bracket 140 and is inserted into the inner circumference 151. The first outer circumference 152 is rotatably inserted into the support hole 146 of the support bracket 140. A rotation cam 170 rotatably engages the third outer circumference 154. The rotation cam 170 has a cam 173 which makes contact with a gear portion 171 of the outer circumferential surface and the protrusion 123 of the recording medium 120. The gear portion 171 of the rotation cam 170 engages with a worm gear 181 provided in a motor 180 (refer to FIGS. 2A and 2B) so as to be rotated by the driving force of the motor 180. The motor 180 is installed in a frame 102 of the image forming apparatus 100 (refer to FIGS. 2A and 2B). The second outer circumference 153 of the bushing 150 is inserted into the hole 103 provided in the frame 102. The rotation cam 170 is supported by a predetermined support (not shown) so as not to separate from the third outer circumference 154. As a result, the support structure 130, the support bracket 140, and the rotation cam 170 are coaxial.

The support bracket 140 has a circular outer circumference 141 having first and second jointing notches 148 and 149 diametrically disposed in opposite positions. A locking member 160 rotatably engages the frame 102. The locking member 160 is resiliently biased by the spring 165 to make contact with the outer circumference 141 of the support bracket 140. The locking member 160 releases from the first or second jointing notch 148 or 149 by the rotation cam 170, and engages with the first or second jointing notch 148 or 149 by an elastic force of the spring 165. The locking member 160 has a locking protrusion 161 which engages the first and second jointing notches 148 and 149 and a snag 162 engaged with the cam 173 of the rotation cam 170.

Now, rotation of the recording head 120 and the support structure 130 will be described in detail with reference to FIGS. 2A, 2B, 3, and 4A through 41.

Referring to FIG. 4A, the recording head 120 and the support structure 130 are pressed by the spring 127 before a printing job is initiated. In addition, since the locking protrusion 161 of the locking member 160 is engaged with the first jointing notch 148, the recording head 120 is locked in a first position. When a printing job is initiated, the recording medium P extracted from the feed cassette by the pick-up roller 115 is delivered to the transport roller 110 via the first path.

Before the recording medium P is transported to the second path, or before the recording medium P is picked up by the pick-up roller 115, the recording head 120 separates from the support structure 130. Referring to FIG. 4B, the rotation cam 170 driven by driving the motor 180 is further rotated to a direction of C1, so that the cam 173 pushes the protrusion 123 of the recording head 120 to a direction of D1, for example, to the downward direction. Since the locking protrusion 161 of the locking member 160 is engaged into the first jointing notch 148, the support bracket 140 does not rotate, and the protrusion 123 is pushed down along the thru-hole 145, so that the recording head 120 is rotated around the hinge hole 122 and separated from the support structure 130. In this state, the transport roller 110 transports the recording medium P to the second path, so that the recording medium P is moved to a gap between the recording head 120 and the pressing plate 132 of the support structure 130.

Referring to FIG. 4C, the rotation cam 170 is rotated to a direction of C2 by driving the motor 180. Since the locking protrusion 161 of the locking member 160 is engaged into the first jointing notch 148, the support bracket 140 still cannot be rotated. The recording head 120 rotates around the hinge hole 122 by an elastic force of the spring 127 so as to make contact with the pressing plate 132 of the support structure 130 again.

In this state, the transport roller 110 transports the recording medium P to the third path, and the thermal spots 121 of the recording head 120 are selectively activated to heat the first surface of the recording medium P, so that images having colors such as magenta or yellow can be printed. The magenta color and the yellow color may be selectively visualized depending on a heating time and a heating temperature of the thermal spots 121. For example, the magenta color may be visualized when the first surface of the recording medium P is heated at a high temperature for a short time, and the yellow color may be visualized when heated at a relatively low temperature for a long time. After the images are formed on the first surface of the recording medium P, the recording medium P is delivered from the second path to the third path, and the transport roller 110 stops transporting the recording medium P.

Referring to FIG. 4D, when the rotation cam 170 is rotated to a direction of C2 by driving the motor 180, the cam 173 pushes the snag 162 to rotate the locking member to a direction of E1. Accordingly, the locking protrusion 161 is released from the first jointing notch 148, and the support bracket 140 becomes rotatable. Subsequently, when the cam 173 continues to rotate to a direction of C2 to push the protrusion 123 of the recording medium 120, the support bracket 140 is rotated to a direction C2 as shown in FIG. 4E. At the same time, the support structure 130 and the recording head 120 engaged into the support bracket 140 are also rotated along with the support bracket 140.

As shown in FIG. 4F, when the support bracket 140 is rotated in 180 degrees, the locking member 160 is rotated to a direction of E2 by an elastic force of the spring 165, so that the locking protrusion 161 is engaged into the second jointing notch 149. The support bracket 140 is locked and does not rotate any more. In this state, the recording head 120 reaches a second position facing the second surface of the recording medium P as shown in FIG. 2B.

Since the locking protrusion 161 is engaged into the second jointing notch 149, although the rotation cam 170 continues to be rotated to a direction of C2, the support bracket 140 does not rotate any more. Instead, as shown in FIG. 4G, the protrusion 123 of the recording head 120 is pushed along the thru-hole 145 by the cam 173, and at the same time, the recording head 120 separates from the support structure 130.

In this state, the transport roller 110 transports the recording medium P from the third path to the second path. When the transport roller 110 stops transporting the recording medium P, and the rotation cam 170 is rotated to a direction C1 again by driving the motor 180, the support bracket 140 does not rotate because the locking protrusion 161 is engaged into the second jointing notch 149. Instead, as shown in FIG. 4H, the recording head 120 makes contact with the pressing plate 132 of the support structure 130 while the protrusion 123 of the recording head 120 moves along the thru-hole 145.

The transport roller 110 transports the recording medium P to the third path again. The recording head 120 applies heat to the second surface of the recording medium P to provide a cyan color by the same method as used when image are formed on the first surface. The recording medium P on which a printing job for the first and the second surfaces has been completed is discharged to the outside of the image forming apparatus by the discharge roller 112.

After the image are printed, as shown in FIG. 4I, the rotation cam 170 is rotated to a direction of C1 and the cam 173 pushes the snag 162 to rotate the locking member 160 to a direction of E1. Accordingly, the locking protrusion 161 separates from the second jointing notch 149, so that the lock of the support bracket 140 is released. Since the cam 173 rotates and pushes the protrusion 123 of the recording head 120, the support bracket 140 is rotated until the locking protrusion 161 is engaged into the jointing notch 148 by an elastic force of the spring 165. Accordingly, the recording head 120 is returned to the first position as shown in FIG. 4A. The recording head 120 waits for a next printing job in this state or in a state separated from the support structure 130 as shown in FIG. 4B.

According to the exemplary embodiments of the present invention, a support structuring having a flat pressing plate is employed instead of a conventional platen roller. Therefore, it is possible to consistently maintain a pressure to the recording medium and improve printing quality. In addition, it is possible to reduce a cost for manufacturing an image forming apparatus because an expensive platen roller is not used.

Furthermore, before the recording medium passes through the recording head, the recording medium is preheated to a predetermined temperature. Therefore, it is possible to provide consistent image quality regardless of an ambient temperature of a place where the image forming apparatus is installed.

While the invention has been shown and described with reference to certain embodiments thereof, it will be understood by those skilled in the art that various changes in form and details may be made therein without departing from the spirit and scope of the invention as defined by the appended claims.

What is claimed is:

1. A thermal type image forming apparatus comprising:
a recording head including a plurality of thermal spots facing a recording medium to heat the recording medium, the thermal spots being selectively activated to form images on the recording medium; and
a support structure including a flat pressing plate pressing the recording medium to the recording head so that the recording medium can make contact with the recording head to form images.

2. The thermal type image forming apparatus of claim 1, further comprising:
a preheating member which preheats the recording medium before the recording medium passes through the thermal spots of the recording medium.

3. The thermal type image forming apparatus of claim 2, wherein the preheating member includes a heater making contact with the support structure, and the heat from the heater is transmitted to the pressing plate; so that the recording medium can be preheated.

4. The thermal type image forming apparatus of claim 3, wherein the preheating member is set to heat the recording medium to a temperature range from about 20 to 30° C. before the images are formed on the recording medium.

5. The thermal type image forming apparatus of claim 1, wherein the pressing plate is made of a metallic material.

6. The thermal type image forming apparatus of claim 1, wherein the pressing plate has a coat which reduces friction with the recording medium.

7. The thermal type image forming apparatus of claim 1, further comprising a pushing element which presses the plate of the support structure toward the recording head, the pushing element including a spring of which one end is connected to the recording head and the other end is connected to the support structure.

8. The thermal type image forming apparatus of claim 1, further comprising a rotating member to rotate the recording head to allow the thermal spots of the recording head to face and heat the both sides of the recording medium.

9. A thermal type image forming apparatus comprising:
a recording head including a plurality of thermal spots facing a recording medium to heat the recording medium, the thermal spots being selectively activated to form images on the recording medium;
a support structure including a flat pressing plate pressing the recording medium to the recording head, the pressing plate having a coat which reduces friction with the recording medium; and
a preheating member which preheats the recording medium before the recording medium passes through the thermal spots of the recording medium.

10. The thermal type image forming apparatus of claim 9, wherein the preheating member includes a heater making contact with the support structure, and the heat from the heater is transmitted to the pressing plate so that the recording medium can be preheated.

11. The thermal type image forming apparatus of claim 10, wherein the preheating member is set to heat the recording medium to a temperature range from about 20 to 30° C. before the images are formed on the recording medium.

12. The thermal type image forming apparatus of claim 9, wherein the pressing plate is made of a metallic material.

13. The thermal type image forming apparatus of claim 9, further comprising a pushing element which presses the plate of the support structure toward the recording head, the pushing element including a spring of which one end is connected to the recording head and the other end is connected to the support structure.

14. The thermal type image forming apparatus of claim 9, further comprising a rotating member to rotate the recording head to allow the thermal spots of the recording head to face and heat the both sides of the recording medium.

15. A thermal type image forming apparatus comprising:
a recording head including a plurality of thermal spots facing a recording medium to heat the recording medium, the thermal spots being selectively activated to form images on the recording medium;
a support structure including a flat pressing plate pressing the recording medium to the recording head so that the recording medium can make contact with the recording head to form images;
a preheating member which preheats the recording medium before the recording medium passes through the thermal spots of the recording medium;
a pushing element which presses the plate of the support structure toward the recording head, the pushing element including a spring of which one end is connected to the recording head and the other end is connected to the support structure; and
a rotating member to rotate the recording head to allow the thermal spots of the recording head to face and heat the both sides of the recording medium.

16. The thermal type image forming apparatus of claim 15, wherein the preheating member includes a heater making contact with the support structure, and the heat from the heater is transmitted to the pressing plate so that the recording medium can be preheated.

17. The thermal type image forming apparatus of claim 16, wherein the preheating member is set to heat the recording medium to a temperature range from about 20 to 30° C. before the images are formed on the recording medium.

18. The thermal type image forming apparatus of claim 15, wherein the pressing plate has a coat which reduces friction with the recording medium.
